(19) United States
(12) Patent Application Publication
(10) Pub. No.: US 2006/0029776 A1
(43) Pub. Date: Feb. 9, 2006

(54) Method of making pressing pattern on rubber-faced member and the rubber-faced member made thereby

(76) Inventor: Jack Wang, Taichung Hsien (TW)

Correspondence Address: BACON & THOMAS, PLLC, 625 SLATERS LANE, FOURTH FLOOR, ALEXANDRIA, VA, 22314, US

(21) Appl. No.: 10/911,691

(22) Filed: Aug. 5, 2004

(51) Int. Cl. B32B 3/00; B44C 3/08

(52) U.S. Cl. 428/172; 428/174; 156/219

(57) ABSTRACT

A rubber-faced member includes a rubber layer on which a pressing pattern is formed, and a thermoplastic base layer bonded to the rubber layer. The rubber-faced member is made by firmly bonding the thermoplastic base layer to a bottom surface of the rubber layer and then directly or indirectly hot pressing the thermoplastic base layer to permanently deform the thermoplastic base layer such that a pressing pattern on the top surface of the rubber layer that is bonded to the thermoplastic base layer is formed corresponding to the deformed portion of the thermoplastic base layer.

### BACKGROUND OF THE INVENTION

1. Field of the Invention

The present invention relates generally to rubber processing methods and more particularly, to a rubber-faced member processing method, which can make a permanent pressing pattern on the surface of a vulcanized rubber layer of the member.

2. Description of the Related Art

Due to the advantages of high elasticity and toughness, rubber is intensively used to make cushions and other shock absorbing materials, for example, grip belt or sheath for the handle of a racket, bat, or any of a variety of sports apparatus. The rubber grip of a sports apparatus greatly lessens transferring of shock waves to the user's hand(s), preventing an athletic injury. Further, the tacky surface structure of rubber provides a good effect against slipping. Therefore, rubber is also intensively sued to make slip-resistant mats, pads, and device coverings. For example, rubber is intensively used as covering means of a conveying belt, grip belt, or grip sheath to prevent slipping of delivered items from the conveying belt or the sports apparatus from the user's hand.

Further, the surface of rubber may be processed to provide a pressing pattern that enhances the slip-resistant characteristic, or to show a company's logo for decorative or advertising purpose. However, surface processing to produce a pressing pattern is applicable to rubber material that is not vulcanized. Vulcanized rubber has the characteristic of thermosetting. The temperature of a hot press during hot press processing process is generally insufficient to structurally deform vulcanized rubber. Although a permanent pressing pattern (plastic deformation) may be achieved on the surface of a vulcanized rubber by a hot press processing process at high temperature, the excessively high temperature may destruct the structure of vulcanized rubber, resulting in loss of elasticity and toughness. Therefore, it is no workable to make a pressing pattern on the surface of vulcanized rubber by means of a hot press processing process. When making a decorative pattern or a company's logo on the surface of vulcanized rubber, transfer-printing or sticker-bonding is commonly employed. However, a decorative pattern or company's logo formed on the surface of vulcanized rubber according to conventional methods do not provide a three-dimensional sense of beauty and will drop from the surface of vulcanized rubber easily.

### SUMMARY OF THE INVENTION

It is the primary objective of the present invention to provide a method of making a pressing pattern on the surface of a rubber-faced member, which is practical to form an embossed pressing pattern on the surface of vulcanized rubber of the rubber-faced member.

To achieve this objective of the present invention, the method comprises the steps of (a) providing a thermoplastic base layer and a rubber layer having a top surface and a bottom surface, (b) bonding at least a part of the thermoplastic base layer to the bottom surface of the rubber layer to form a rubber-faced member, and (c) hot pressing the rubber-faced member to permanently deform a part of the thermoplastic base layer that is bonded to the rubber layer into a deformed portion such that a pressing pattern on the top surface of the rubber layer is formed corresponding to the deformed portion of the thermoplastic base layer due to the stretchability of deformation of the thermoplastic base layer.

### BRIEF DESCRIPTION OF THE DRAWINGS

FIGS. 1A-1C are a series of schematic sectional views showing the steps of the method according to the present invention.

FIG. 2 illustrates installation of a grip belt in the handle of a sports apparatus according to the present invention.

FIG. 3 is a perspective view of a rectangular sheet member of rubber-faced member according to the present invention.

FIG. 4 shows a tubular grip sheath formed of the rectangular sheet member of rubber-faced member shown in FIG. 3.

### DETAILED DESCRIPTION OF THE INVENTION

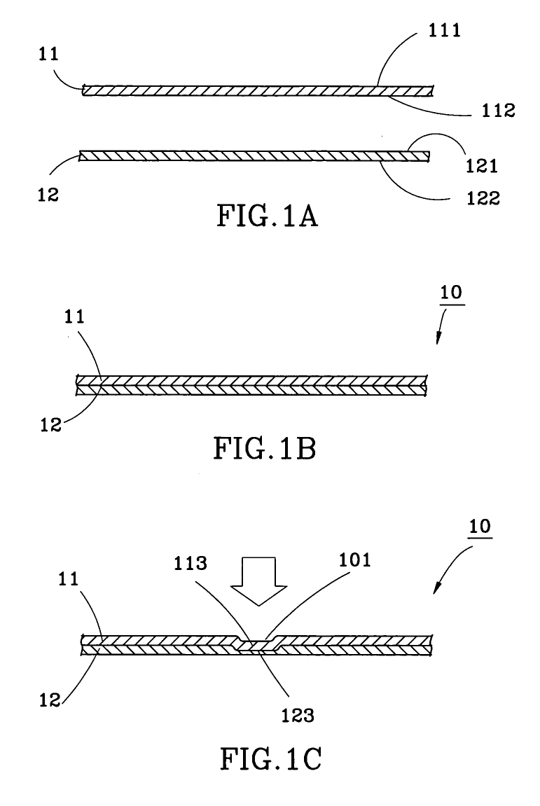

Referring to FIGS. 1A-1C, a rubber-faced member 10 is shown comprising a vulcanized rubber layer 11 and a base layer 12 made of thermoplastic material. The rubber layer 11 has a top surface 111 and a bottom surface 112. The base layer 12 has a top surface 121 and a bottom surface 122. The manufacturing steps of the rubber-faced member 10 are recited hereunder.

At first, the rubber layer 11 and the thermoplastic base layer 12 are respectively held in horizontal and vertically aligned, as shown in FIG. 1A. And then, the bottom surface 112 of the rubber layer 11 is bonded to the top surface 121 of the base layer 12 by glue or ultrasonic sealing, as shown in FIG. 1B. After bonding, the rubber-faced member 10 is put in a hot press (not shown) and pressed by the hot press, causing the pressed part of the base layer 12 to deform permanently and to form a recessed portion 123. By means of the stretchability of deformation of the recessed portion 123, the corresponding part 113 of the rubber layer 11 is curved downwards, forming a recessed pressing pattern 101. The rubber layer 11 and the thermoplastic base layer 12 have a thickness within about 0.3 mm to 1.2 mm.

Due to thermosetting property, vulcanized rubber material is not suitable for surface processing by hot pressing to form a pressing pattern on the surface thereof. By means of bonding of the thermoplastic base layer 12 to the rubber layer 11, the rubber layer 11 can be stretched to deform by permanently deforming the thermoplastic base layer 12 by means of a hot press. The thermoplastic base layer 12 can be formed of PU (polyurethane) or EVA (ethylene vinyl acetate). By means of permanent deformation of the thermoplastic base layer 12 to stretch the rubber layer 11, a pressing pattern is formed on the surface of the rubber-faced member 10. The pressing pattern on the surface of the rubber-faced member 10 is produced due to elastic deformation of the rubber layer 11. Tightly joining between the rubber layer 11 and the thermoplastic base layer 12 causes the rubber layer 11 to deform elastically when processed the thermoplastic base layer 12 with a hot press, and therefore the desired pressing pattern is in presence on the surface of the rubber layer 11. It is to be understood that the invention can also have the thermoplastic base layer 12 be bonded to the rubber layer 11 at the area corresponding to the desired recessed pressing pattern 101, i.e. the thermoplastic base layer 12 doesn't have to be bonded to the rubber layer 11 at whole area thereof.

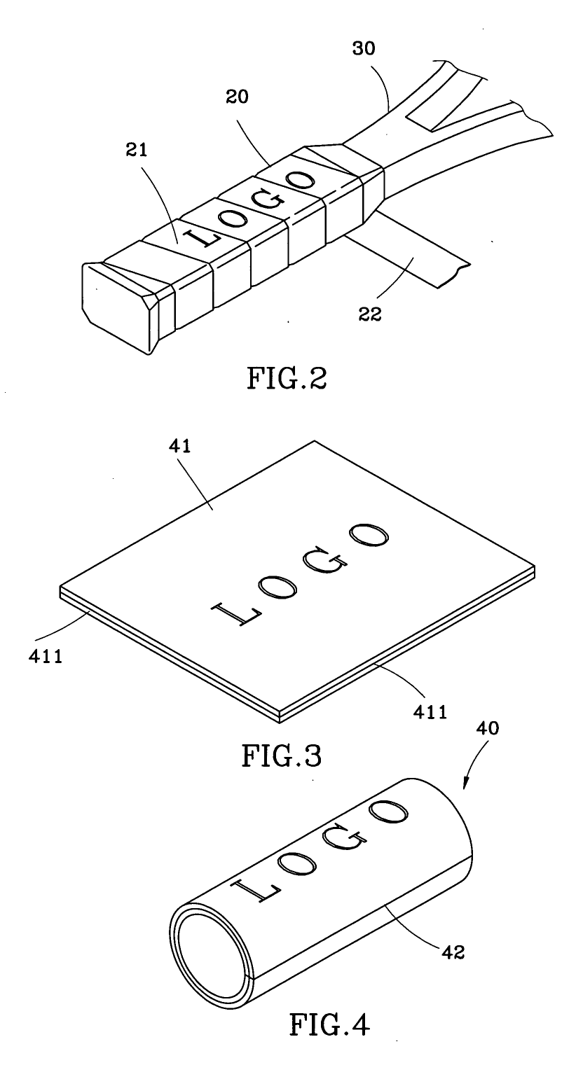

FIG. 2 shows a grip belt 20 made of the rubber-faced member 10 according to the present invention and fastened to the periphery of the handle 30 of a sports apparatus, for example, a tennis racket. The grip belt 20 comprises a top (outer) rubber layer 21 and a bottom (inner) thermoplastic base layer 22. The top (outer) rubber layer 21 has a slip-resistant pressing pattern on the surface. The bottom (inner) thermoplastic base layer 22 is bonded to the outside wall of the handle 30. After installation of the grip belt 20 in the handle 30, the rubber layer 11 is exposed to the outside for gripping by the user. Because the rubber layer 11 is elastic and tough, it provides a satisfactory shock absorbing effect. The pressing pattern, which is produced on the surface of the rubber layer 11 after a hot pressing process, provides a good slip-resistant effect, preventing slipping of the user's hand from the grip due to sweating during exercise. The pressing pattern on the surface of the rubber layer 11 can be so made to show a company's logo, trademark, or the like.

Simply using rubber to make a grip belt for the handle of a sports apparatus is not a good ideal because the rubber grip belt cannot be directly processed through a hot press to provide a slip-resistant pressing pattern, and the user's hand will slip when sweating. According to the present invention, the slip-resistant pressing pattern on the surface of the grip belt produces friction to the user's hand, and the user can still hold the handle of the sports apparatus positively even when the hand is sweating. Further, the company's logo, trademark, or like that is formed of the slip-resistant pressing pattern on the surface of the belt grip shows a three-dimensional sense of beauty.

Referring to FIGS. 3 and 4, a rubber-faced member in accordance with the present invention can be made in the shape of a rectangular sheet member of rubber-faced member 41. The two opposite long sides 411 of the sheet member of rubber-faced member 41 are sealed into a seam line 42, and therefore the rectangular sheet member of rubber-faced member 41 forms a tubular grip sheath 40. Further, because the tubular grip sheath 40 has a slip-resistant pressing pattern on the surface of the rubber-faced member 41, the user's hand does not slip from the tubular grip sheath 40 during exercise. Further, because the slip-resistant pressing pattern can be made in the shape of a company's logo, trademark, or the like, it shows a sense of beauty.

In conclusion, the spirit of the present invention is to make a bottom layer from a hot press-processible thermoplastic material and then to join the bottom layer to a vulcanized rubber layer, and then to process the combined material with hot pressing, causing the permanently deformed bottom layer to hold the rubber layer in a deformed status, showing a pressing pattern on the surface.

Although a particular embodiment of the invention has been described in detail for purposes of illustration, various modifications and enhancements may be made without departing from the spirit and scope of the invention. For example, the hot press can be operated to press the thermoplastic base layer 12 against the rubber layer 11, thereby forming a protruded pressing pattern on the surface of the rubber layer of the rubber-faced member. Accordingly, the invention is not to be limited except as by the appended claims.

What is claimed is:

1. A method of making a pressing pattern on a rubber-faced member, the method comprising the steps of:
(a) providing a thermoplastic base layer and a rubber layer having a top surface and a bottom surface;
(b) bonding at least a part of said thermoplastic base layer to the bottom surface of said rubber layer to form a rubber-faced member; and
(c) hot pressing the rubber-faced member to permanently deform a part of said thermoplastic base layer that is bonded to said rubber layer into a deformed portion such that a pressing pattern on the top surface of said rubber layer is formed corresponding to said deformed portion of said thermoplastic base layer.

2. The method as claimed in claim 1, wherein said rubber layer has a thickness ranging from 0.3 mm to 1.2 mm.

3. The method as claimed in claim 1, wherein the step (c) of hot pressing said rubber-faced member is achieved by pressing said rubber layer against said thermoplastic base layer such that the pressing pattern formed on the top surface of said rubber layer is recessed.

4. The method as claimed in claim 1, wherein the step (c) of hot pressing said rubber-faced member is achieved by pressing said thermoplastic base layer against said rubber layer such that the pressing pattern formed on the top surface of said rubber layer is protruded.

5. The method as claimed in claim 1, wherein said thermoplastic base layer has a whole area bonded to the bottom surface of said rubber layer in the step (b).

6. The method as claimed in claim 1, wherein said thermoplastic base layer is made from polyurethane.

7. The method as claimed in claim 1, wherein said thermoplastic base layer is made from ethylene vinyl acetate.

8. A rubber-faced member comprising:
a rubber layer having a top surface and a bottom surface; and
a thermoplastic base layer bonded to the bottom surface of said rubber layer, said thermoplastic base layer having a permanently deformed portion that is produced by a hot press processing process such that a deformation pattern on the top surface of said rubber layer is formed corresponding to the permanently deformed portion of said thermoplastic base layer.

9. The rubber-faced member as claimed in claim 8, wherein said thermoplastic base layer is made from polyurethane.

10. The rubber-faced member as claimed in claim 8, wherein said thermoplastic base layer is made from ethylene vinyl acetate.

11. The rubber-faced member as claimed in claim 8, wherein said rubber layer has a thickness ranging from 0.3 mm to 1.2 mm.

12. The rubber-faced member as claimed in claim 8, wherein said deformation pattern is a recessed pattern recessed inwardly on the top surface of said rubber layer.

13. The rubber-faced member as claimed in claim 8, wherein said deformation pattern is a protruded pattern protruded upwardly from the top surface of said rubber layer.

14. A grip belt for spirally winding around a handle of a sports apparatus to form a grip on the handle of the sports apparatus, said grip belt comprising:
a rubber layer having a top surface exposed for gripping by a user and a bottom surface; and
a thermoplastic base layer bonded to the bottom surface of said rubber layer, said thermoplastic base layer having a permanently deformed portion that is produced by a hot press processing process such that a deformation pattern on the top surface of said rubber layer is formed corresponding to the permanently deformed portion of said thermoplastic base layer.

15. The grip belt as claimed in claim 14, wherein said thermoplastic base layer is made from polyurethane.

16. The grip belt as claimed in claim 14, wherein said thermoplastic base layer is made from ethylene vinyl acetate.

17. The grip belt as claimed in claim 14, wherein said deformation pattern is a recessed pattern recessed inwardly on the top surface of said rubber layer.

18. The grip belt as claimed in claim 14, wherein said deformation pattern is a protruded pattern protruded upwardly from the top surface of said rubber layer.

19. The grip belt as claimed in claim 14, wherein said rubber layer has a thickness ranging from 0.3 mm to 1.2 mm.

20. A grip sheath comprising:
a rubber-faced member having two opposite sides connected together;
wherein the rubber-faced member comprises a rubber layer having a top surface exposed for gripping by a user and a bottom surface, and a thermoplastic base layer bonded to the bottom surface of said rubber layer, said thermoplastic base layer having a permanently deformed portion that is produced by a hot press processing process such that a deformation pattern on the top surface of said rubber layer is formed corresponding to the permanently deformed portion of said thermoplastic base layer.

21. The grip sheath as claimed in claim 20, wherein said thermoplastic base layer is made from polyurethane.

22. The grip sheath as claimed in claim 20, wherein said thermoplastic base layer is made from ethylene vinyl acetate.

23. The grip sheath as claimed in claim 20, wherein said deformation pattern is a recessed pattern recessed inwardly on the top surface of said rubber layer.

24. The grip sheath as claimed in claim 20, wherein said deformation pattern is a protruded pattern protruded upwardly from the top surface of said rubber layer.

25. The grip sheath as claimed in claim 20, wherein said rubber layer has a thickness ranging from 0.3 mm to 1.2 mm.
